(19) United States
(12) Patent Application Publication
(10) Pub. No.: US 2026/0275072 A1
(43) Pub. Date: Sep. 17, 2026

(54) APPARATUS AND METHOD FOR REGENERATING BLEND RESIN

(71) Applicant: HONDA MOTOR CO., LTD., Tokyo (JP)

(72) Inventors: Ryo NAKAI, Saitama (JP); Keishi ASADA, Saitama (JP)

(21) Appl. No.: 19/561,542

(22) Filed: Mar. 10, 2026

(30) Foreign Application Priority Data
Mar. 12, 2025 (JP) 2025-039537

(51) Int. Cl. C08J 11/24

(52) U.S. Cl. CPC C08J 11/24; C08J 2367/03

(57) ABSTRACT

Provided is a technology capable of stably recovering and reusing THF to be used as a solvent for depolymerization in polymerizing and regenerating a blend resin. A blend resin regeneration apparatus includes a depolymerization tank that allows for depolymerization of a blend resin including a polyester resin in a solution including a strong base dissolved in a solvent including tetrahydrofuran and methanol; a storage tank that stores the solvent recovered from a reaction liquid after the depolymerization; and a first supplier that supplies the strong base into the storage tank.

This application is based on and claims the benefit of priority from Japanese Patent Application No. 2025-039537, filed on 12 Mar. 2025, the content of which is incorporated herein by reference.

### BACKGROUND OF THE INVENTION

### Field of the Invention

The present invention relates to a blend resin regeneration apparatus and a method for regenerating the blend resin.

### Related Art

In recent years, efforts to significantly reduce waste have intensified through recycling waste. To this end, research and development of recycling of blend resin is being carried out.

Japanese Unexamined Patent Application, Publication No. 2024-125271 discloses a technology for recycling waste blend fiber products including polyester fibers and cotton staple fibers. In this technology, polyester fibers are depolymerized in a basic aqueous solution under controlled environment to obtain a treated fiber product including cotton staple fibers.

Incidentally, various solvents are used as solvents for depolymerization of a blend resin including a polyester resin, and from the viewpoint of waste reduction, it is desirable to recover and reuse also solvents used for regeneration of the blend resin.
Patent Document 1: Japanese Unexamined Patent Application, Publication No. 2024-125271

### SUMMARY OF THE INVENTION

However, when a solvent including tetrahydrofuran (THF) having excellent solubility and methanol (MeOH) is used as a solvent for depolymerization of a blend resin including polyester resin, THF has a characteristic of being easily oxidized to form peroxide when in contact with oxygen. Therefore, recovering and reusing THF involve a problem relating to the stability of the recovered THF.

The present invention has an object to provide a technology capable of stably recovering and reusing THF to be used as a solvent for depolymerization in polymerizing and regenerating a blend resin.

(1) A blend resin regeneration apparatus (for example, a regeneration apparatus 1 described later) includes a depolymerization tank (for example, a depolymerization tank 11 described later) tank that allows for depolymerization of a blend resin including polyester resin in a solution including a strong base dissolved in a solvent including tetrahydrofuran and methanol; a storage tank (for example, a storage tank 12 described later) that stores the solvent recovered from a reaction liquid after the depolymerization; and a first supplier (for example, a first supplier 15 described later) that supplies the strong base into the storage tank.

(2) In the blend resin regeneration apparatus described in (1), the first supplier supplies sodium hydroxide as the strong base into the storage tank.

(3) The blend resin regeneration apparatus described in (1) or (2) further includes a second supplier (for example, a second supplier 16 described later) that supplies methanol to the recovered solvent.

(4) In the blend resin regeneration apparatus described in (3), the second supplier supplies methanol into the storage tank.

(5) The blend resin regeneration apparatus described in any one of (1) to (4) further includes a purge device (for example, a purge device 17 described later) that purges an inside of the storage tank with an inert gas.

(6) The blend resin regeneration apparatus described in any one of (1) to (5) further includes a liquid feeder (for example, a liquid feeding pump 14 described later) that feeds the solution stored in the storage tank and including the strong base dissolved in the solvent to the depolymerization tank.

(7) A method for regenerating a blend resin includes a depolymerization reaction step including depolymerizing a blend resin including polyester resin in a solution including a strong base dissolved in a solvent including tetrahydrofuran and methanol (for example, a depolymerization reaction step as Step S2 described later); a solvent storage step including supplying the strong base to the solvent recovered from a reaction liquid after the depolymerization, and storing the solvent (for example, a solvent removal step as Step S3 described later, and a solvent recovering step as Step S4 and a solvent storing step as Step S5 described later).

The present invention can provide a technology capable of stably recovering and reusing THF to be used as a solvent for depolymerization in polymerizing and regenerating a blend resin.

### BRIEF DESCRIPTION OF THE DRAWINGS

FIG. 1 is a diagram schematically showing a configuration of a blend resin regeneration apparatus according to one embodiment of the present invention; and

FIG. 2 is a flowchart showing a process procedure of a method for regenerating the blend resin according to one embodiment of the present invention.

### DETAILED DESCRIPTION OF THE INVENTION

Hereinafter, one embodiment of the present invention is described in more detail with reference to the drawings.

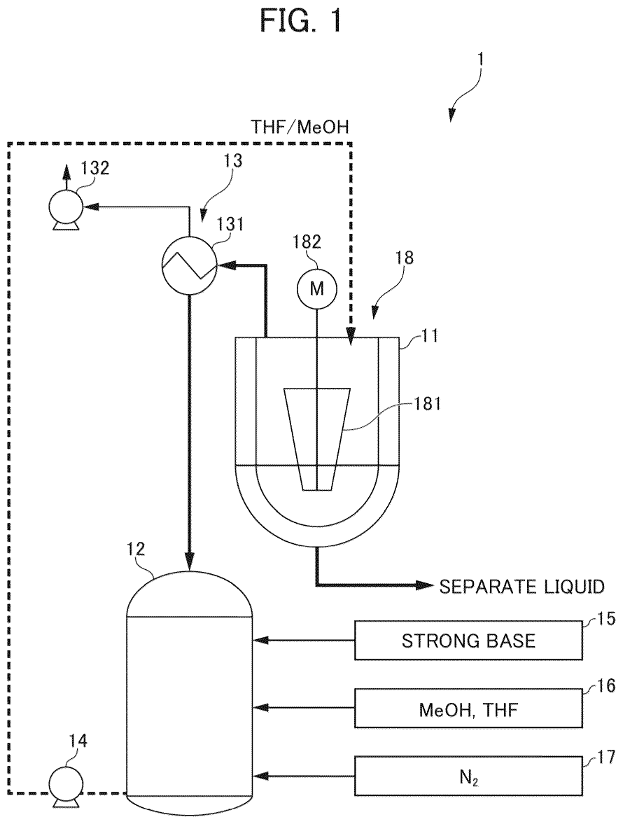

A blend resin regeneration apparatus according to the present embodiment is an apparatus capable of depolymerizing and regenerating a blend resin, and stably recovering and reusing THF to be used as a solvent for depolymerization. FIG. 1 is a diagram schematically showing a configuration of a blend resin regeneration apparatus 1 according to the present embodiment. As shown in FIG. 1, the blend resin regeneration apparatus 1 according to the present embodiment includes a depolymerization tank 11, a storage tank 12, a recovery device 13, a liquid feeder 14, a first supplier 15, a second supplier 16, a purge device 17, and a stirring device 18. Note here that an open/close valve or the like (not shown) is provided in a piping path linking these component devices, and the regeneration apparatus 1 is driven and controlled by a control device (not shown) for controlling the component devices and the open/close valve or the like, and the blend resin is regenerated.

The blend resin used in the present embodiment include at least polyester resin, and may be a mixture of the polyester resin and a plurality of resins other than the polyester resin. The blend resin may include at least one of a polyurethane (PU) resin, a polyethylene (PE) resin, a polypropylene (PP) resin, a polyamide (PA) resin such as nylon, cotton, an acrylic resin, wool and rayon, in addition to the polyester resin. As the polyester resin, for example, polyethylene terephthalate (PET) is used. Furthermore, the blend resin may be a blend fiber composed of resin fibers. As the blend resin, for example, a resin derived from an end of life vehicle (ELV) or a resin derived from clothing is used.

The depolymerization tank 11 allows a blend resin including polyester resin to be depolymerized in a solution in which a strong base is dissolved in a solvent including THF and methanol. The depolymerization temperature is not particularly limited, and is, for example, 45° C. or more and 75° C. or less. Furthermore, the depolymerization time is not particularly limited, and, for example, 5 hours or more and 20 hours or less.

Methanol used as a solvent for depolymerization in the present embodiment is considered to have a function as a reaction solvent for transesterification of polyester resin, and a function as a solvent for dissolving a strong base. Specifically, it is considered that CH₃O⁻ generated by the strong base reacts with the polyester resin, and OH⁻ and CH₃O⁻ compete with each other. For example, when water and a strong base are used, the affinity (solubility) with the polyester resin is poor, so that a high temperature is required to allow the reaction to proceed; and THF and water are not compatible, so that the reaction is considered to be difficult to occur.

The depolymerization tank 11 is provided with the stirring device 18 for stirring a reaction liquid in the depolymerization tank 11. The stirring device 18 includes a stirrer 181 for stirring the reaction liquid in the depolymerization tank 11, and a motor 182 for rotationally driving the stirrer 181. The reaction liquid in the depolymerization tank 11 is stirred by the stirring device 18, raw materials are well mixed, and the depolymerization reaction proceeds efficiently.

The storage tank 12 stores a solvent recovered by a recovery device 13 described later from the reaction liquid after depolymerization of the blend resin. The recovered solvents include THF and methanol.

The recovery device 13 recovers a solvent from the reaction liquid inside the depolymerization tank 11 after the blend resin is depolymerized. Specifically, the recovery device 13 includes a condenser 131 and a vacuum pump 132. The vacuum pump 132 depressurizes the inside of the depolymerization tank 11 after the depolymerization, promotes vaporization of the solvent in the reaction liquid at a high temperature (for example, 40° C. or more and 75° C. or less) after depolymerization, and introduces the solvent into the condenser 131. The condenser 131 cools and condenses the introduced gas solvent to be liquefied, and the liquid is then fed to the storage tank 12.

Note here that the solvent recovered by the recovery device 13 includes THF and methanol, but the ratio thereof is different from that in a charging raw material. Specifically, in the depolymerization of, for example, a polyester resin such as polyethylene terephthalate (also referred to as PET) and the like, since methanol is used also for the methyl esterification of a carboxylic acid, the content ratio of methanol in the recovered solvent is smaller than that in the charging raw material.

The liquid feeder 14 feeds a solution, which is stored in the storage tank 12 and in which a strong base is dissolved in a solvent, to the depolymerization tank 11. Specifically, the liquid feeder 14 includes a liquid feeding pump. The solvent for depolymerization is recycled by the liquid feeder 14. Note here that the reason why THF to be used as the solvent for depolymerization can be recovered and reused will be described in detail in the paragraph later.

The first supplier 15 supplies a strong base into the storage tank 12. The strong base is not particularly limited as long as the strong base can depolymerize polyester resin, and examples include sodium hydroxide, potassium hydroxide, barium hydroxide, strontium hydroxide, and lithium hydroxide. Among them, sodium hydroxide is preferably used. The first supplier 15 supplies the strong base so that the concentration of the strong base dissolved in the solvent in the storage tank 12 is, for example, 0.02 g/mL or more and 0.14 g/mL or less.

The second supplier 16 supplies methanol and THF to the solvent recovered by the above-described recovery device 13. As described above, the solvent recovered by the recovery device 13 includes THF and methanol, but the ratio of them is different from that in the charging raw material. Specifically, the content ratio of the methanol in the recovered solvent is smaller than that in the charging raw material. Therefore, the second supplier 16 supplies and compensates a shortage of methanol so that the methanol ratio in the recovered and stored solvent coincide with that in the charging raw material. Thus, since methanol is compensated before the solvent for depolymerization is recovered and reused, the charging amount of the raw material can be made constant. Furthermore, since the recovery of THF by the recovery device 13 is not complete, THF is also compensated by the second supplier 16.

FIG. 1 shows an example in which the second supplier 16 supplies methanol and THF into the storage tank 12. In this case, the second supplier 16 can share a supply unit such as supply pump (not shown) with the above-described first supplier 15.

The purge device 17 purges the inside of the storage tank 12 with an inert gas. In the example shown in FIG. 1, the purge device 17 supplies nitrogen N₂ as the inert gas to the inside of the storage tank 12, and the air in the storage tank 12 is purged with nitrogen N₂. This can suppress contamination of air into a solvent that can be generated by the supply of a strong base by the first supplier 15, and by the supply of methanol by the second supplier 16.

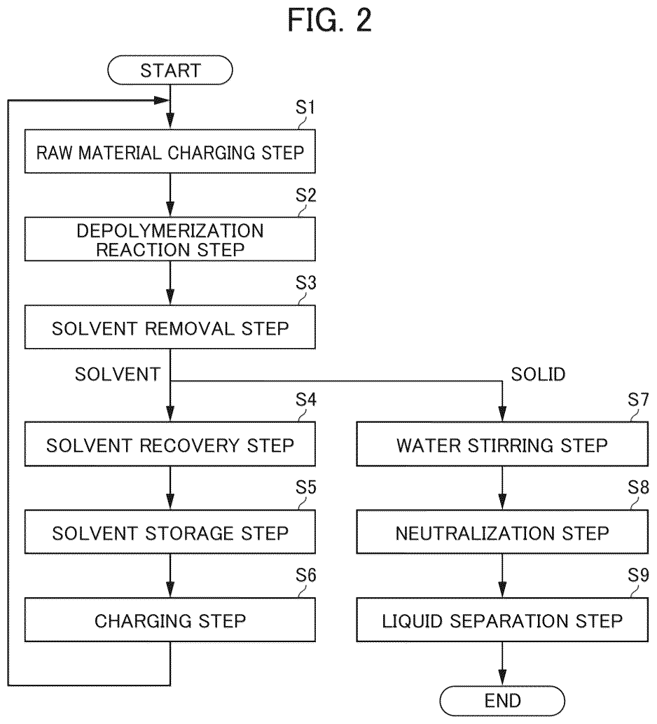

Next, a method for regenerating a blend resin according to the present embodiment will be described. FIG. 2 is a flowchart showing a process procedure of the method for regenerating the blend resin according to the present embodiment. In FIG. 2, processes of Steps S1 to S6 are executed by the above-described regeneration apparatus 1.

In a raw material charging step as Step S1, a process of charging raw material is executed. Specifically, the blend resin including a polyester resin, a mixed solvent of THF and methanol for depolymerization, and sodium hydroxide of a strong base are loaded into the depolymerization tank 11 at a predetermined ratio, and mixed by stirring with the stirring device 13 to obtain a raw material.

In a depolymerization reaction step as Step S2, a depolymerization reaction process of the blend resin is executed in the depolymerization tank 11. For example, the depolymerization reaction is allowed to proceed at a depolymerization temperature of 45° C. or more and 75° C. or less, and a depolymerization time of 5 hours or more and 20 hours or less.

In a solvent removal step as Step S3, after the depolymerization reaction, a process of removing the solvent from the reaction liquid at a high temperature (for example, 40° C. or more and 75° C. or less) is executed in the depolymerization tank 11. Specifically, the pressure in the depolymerization tank 11 is reduced by the vacuum pump 132 of the recovery device 13, and vaporization of the solvent is promoted to remove the solvent.

In a solvent recovery step as Step S4, a process of recovering the solvent removed in Step S3 is executed. Specifically, the solvent vaporized and removed is recovered by condensing and liquefying the solvent by the condenser 131 of the recovery device 13.

In a solvent storage step as Step S5, the solvent recovered in Step S4 is introduced into and stored in the storage tank 12. The recovered solvent is stored in the storage tank 12 for reuse in the next depolymerization reaction of the blend resin.

In a charging step as Step S6, a strong base, for example, sodium hydroxide is supplied to the recovered and stored solvent. Furthermore, methanol is supplied to the recovered and stored solvent for compensation, and the methanol ratio is adjusted so as to coincide with that in the charging raw material. At this time, a purging process of purging the inside of the storage tank 12 with an inert gas (nitrogen N₂) is also executed by the purge device 17.

After the charging step, the solvent stored in the storage tank 12 is subjected to the raw material charging step of Step S1 to be reused in the next depolymerization of the blend resin. Thus, the solvent for depolymerization is reused.

On the other hand, the water stirring step as Step S7 executes a water stirring process, in which water is added to a solid component from which the solvent has been removed in the solvent removal step of Step S3, and stirring is performed. Specifically, an appropriate amount of ion-exchanged water is added to the solid component, and stirring process is executed, for example, at room temperature for 1 hour.

In the neutralization step as Step S8, a neutralization process is executed to the aqueous solution obtained in Step 7. Specifically, a strong acid, for example, an appropriate amount of 2N sulfuric acid aqueous solution is added to the aqueous solution obtained in Step 7, and the solution is stirred and neutralized so that the pH thereof becomes around 7. At this time, the neutralization process is executed to such a degree that, for example, terephthalic acid obtained by depolymerization of polyethylene terephthalate as the polyester resin does not precipitate.

In the liquid separation step as Step S9, a liquid separation process is executed to the aqueous solution neutralized in Step S8. Specifically, an appropriate amount of, for example, ethyl acetate as an organic solvent is added to the aqueous solution neutralized in Step S8, followed by stirring and liquid separation. By repeating this separation operation a plurality of times, the liquid is separated into an aqueous phase and an oil phase (an ethyl acetate phase), and, for example, terephthalic acid as a depolymerized product of polyester resin can be obtained from the aqueous phase, and a depolymerized product of a polyurethane resin can be obtained from the oil phase. As mentioned above, the process of the method for regenerating a blend resin is completed.

Next, the reason why THF to be used as the solvent for depolymerization can be stably recovered and reused in the regeneration apparatus 1 according to the present embodiment will be described below in detail.

Since THF has a low boiling point and excellent solubility, THF is widely used for dissolutions and reaction solvents of various materials. On the other hand, THF has a characteristic of being easily oxidized to form a peroxide when THF is brought into contact with oxygen. Specifically, when oxygen is brought into contact with THF, an alkyl radical R. and an organic peroxide radical RO₂· are generated, and an autooxidation chain proceeds by the reaction shown in the following reaction formulae (1) and (2) to generate THF peroxide ROOH. Furthermore, the autooxidation chain is branched by the reaction shown in the following reaction formula (3), the THF peroxide ROOH is decomposed, and alkoxy radical RO· and hydroxyl radical OH are generated.

[Chem. 1]

R·+O₂→RO₂· Reaction formula (1)

RO₂·+RH→ROOH+R· Reaction formula (2)

ROOH→RO·+·OH Reaction formula (3)

When production amounts of the alkoxy radical RO· and hydroxyl radical ·OH generated by the above reaction formula (3) are a predetermined amount or more, the stability of THF can be kept. Therefore, new THF always contains dibutylhydroxytoluene (hereinafter, also referred to as BHT) as an antioxidant.

BHT has a function of preventing oxidation of THF by preventing the above-described autooxidation chain reaction by capturing highly active radicals. Specifically, the highly active organic peroxide radical RO₂·, which is generated simultaneously with the THF peroxide ROOH, is captured by the reactions shown in the following reaction formulae (4) and (5) to generate a non-radical product. Note here that in the following reaction formula (4), BOH represents BHT, and BO· represents a hydroxyl radical derived from BHT.

[Chem. 2]

RO₂·+BOH→ROOH+BO· Reaction formula (4)

RO₂·+BO·→non-radical product Reaction formula (5)

As shown in the above reaction formulae (4) and (5), since the radical BO· captured by BHT is stabilized by resonance, it is difficult to generate a new radical by chain transfer. Therefore, the organic peroxide radical RO₂· is made to be non-radical by BHT, and as a result, the autooxidation chain reaction shown in the above reaction formulae (1) and (2) is stopped. This improves the stability of THF.

By the way, new THF to be used for the first charging of raw materials always contains BHT as described above. On the contrary, THF and methanol (THF/MeOH) of the solvent recovered by the recovery device 13 do not contain BHT because the THF and methanol have undergone condensation. Therefore, prevention of oxidation of THF in the recovered solvent is required.

Herein, in a blend resin regeneration apparatus 1 according to the present embodiment, as described above, the strong base required for depolymerizing the polyester resin is supplied into the storage tank 12 by the first supplier 15, and the strong base exerts a function of preventing oxidation of THF. Specifically, the strong base prevents radical formation by decomposition of the THF peroxide ROOH by changing the THF peroxide ROOH to a non-peroxide. In other words, the strong base inhibits formation of the alkoxy radical RO· and hydroxyl radical ·OH formed by decomposition of the THF peroxide ROOH by the reaction formula (3).

For example, sodium hydroxide as a strong base is considered to change the above-mentioned THF peroxide ROOH to a non-peroxide by the reaction shown in the following reaction formulae (6), (7) and (8). Thus, proceeding of the above reaction formula (3) is prevented and the stability of THF is improved.

[Chem. 3]

ROOH+NaOH→RO₂⁻+Na⁺+H₂O Reaction formula (6)

RO₂⁻+ROOH→RO⁻+ROH+O₂ Reaction formula (7)

ROOH+OH⁻→[ROOH]⁻+H₂O→R═O+OH⁻+H₂O Reaction formula (8)

Therefore, according to the regeneration apparatus 1 of the present embodiment, oxidation of THF in the solvent THF/MeOH stored in the storage tank 12 can be effectively prevented without separately adding an antioxidant such as BHT. Furthermore, since the oxidation prevention reaction by BHT does not proceed in the storage tank 12, the THF peroxide ROOH and the non-radical product shown in the above reaction formulae (4) and (5) are not generated, and the generation of impurities can be suppressed.

The embodiment of the present invention has been described above, but the present invention is not limited to the embodiment described above, and the embodiment may be appropriately modified within the scope of the spirit of the present invention.

### Examples

Hereinafter, Example of the present invention is described, but the present invention is not limited to this Example.

Firstly, in addition to PET as polyester resin, blend resin including PU resin, PP resin, PE resin, nylon 6 (PA6) as a PA resin, and cotton was prepared. To 4 g of the blend resin, 50 mL of new tetrahydrofuran, 50 mL of methanol, and 2 g of sodium hydroxide were added and the mixture was loaded into the depolymerization tank 11. After the loading, the mixture was stirred at 65° C. for 20 hours to depolymerize the blend resin.

After the depolymerization, the solvent was recovered by a recovery device 13 and stored in the storage tank 12. At this time, the first supplier 15 supplied sodium hydroxide as a strong base to the storage tank 12. Furthermore, the first supplier 16 supplied methanol to the storage tank 12 so that the ratio of the solvent of the charging raw material agreed with the ratio of methanol. Then, the liquid feeder 14 subjected the solvent stored in the storage tank 12 to the next depolymerization reaction.

On the other hand, 150 mL of water was added to a solid from which the solvent had been distilled off, and the mixture was stirred at room temperature for 1 hour. After stirring, 2N sulfuric acid aqueous solution was added until pH became 6.5 to 7.5, then 150 mL of ethyl acetate was added, and the mixture was stirred at room temperature for 5 minutes.

Then, an insoluble material was filtered under reduced pressure with a Buchner funnel, a filtrate was washed with a mixed solvent (20 mL of water/20 mL of ethyl acetate), and dried at 80° C. overnight to recover a mixture of PP resin, PE resin, PA6, and cotton.

Then, the filtrate was introduced into a liquid separation funnel, and an operation of extracting the PU depolymerized product into 150 mL of ethyl acetate was repeated three times to recover the aqueous phase and the oil phase, respectively.

After 150 mL of saturated saline was added to the oil phase, the oil phase was washed and recovered using a liquid separation funnel. Thereafter, magnesium sulfate was added so as to dry the oil phase, followed by filtration under reduced pressure, and the magnesium sulfate was washed with 20 mL of ethyl acetate.

Then, the solvent was distilled off from the filtrate by using an evaporator and dried at 80° C. overnight to recover the PU depolymerized product (polyol PO).

On the other hand, 2N sulfuric acid aqueous solution was added to the aqueous phase until the pH became 2 to precipitate terephthalic acid (TPA), followed by filtration under reduced pressure. Finally, the filtrate was washed with 20 ml of methanol and dried at 80° C. overnight to recover TPA.

As mentioned above, according to the present embodiment, it has been demonstrated that a blend resin can be depolymerized, and regenerated. Furthermore, at the same time, according to the present embodiment, it has been demonstrated that THF to be used as the solvent for depolymerization can be stably recovered and reused. Thus, the effect of the present invention has been verified.

### EXPLANATION OF REFERENCE NUMERALS

1 regeneration apparatus
11 depolymerization tank
12 storage tank
13 recovery device
131 condenser
132 vacuum pump
14 liquid feeding pump (liquid feeder)
15 first supplier
16 second supplier
17 purge device
19 stirring device
191 stirrer
192 motor

What is claimed is:

1. A blend resin regeneration apparatus comprising:
a depolymerization tank that allows for depolymerization of a blend resin comprising polyester resin in a solution comprising a strong base dissolved in a solvent comprising tetrahydrofuran and methanol;
a storage tank that stores the solvent recovered from a reaction liquid after the depolymerization; and
a first supplier that supplies the strong base into the storage tank.

2. The blend resin regeneration apparatus according to claim 1, wherein the first supplier supplies sodium hydroxide as the strong base into the storage tank.

3. The blend resin regeneration apparatus according to claim 1, further comprising a second supplier that supplies methanol to the recovered solvent.

4. The blend resin regeneration apparatus according to claim 3, wherein the second supplier supplies methanol into the storage tank.

5. The blend resin regeneration apparatus according to claim 1, further comprising a purge device that purges an inside of the storage tank with an inert gas.

6. The blend resin regeneration apparatus according to claim 1, further comprising a liquid feeder that feeds the solution stored in the storage tank and including the strong base dissolved in the solvent to the depolymerization tank.

7. A method for regenerating a blend resin, the method comprising:
a depolymerization reaction step including depolymerizing a blend resin comprising polyester resin in a solution comprising a strong base dissolved in a solvent including tetrahydrofuran and methanol; and
a solvent storage step including supplying the strong base to the solvent recovered from a reaction liquid after the depolymerization, and storing the solvent.
